(19) United States
(12) Patent Application Publication
(10) Pub. No.: US 2020/0060918 A1
(43) Pub. Date: Feb. 27, 2020

(54) MULTI-SURFACE INSTRUMENT FOR SOFT TISSUE MOBILIZATION

(71) Applicant: Edward W. Bezkor, Carlsbad, CA (US)

(72) Inventor: Edward W. Bezkor, Carlsbad, CA (US)

(21) Appl. No.: 16/549,905

(22) Filed: Aug. 23, 2019

Related U.S. Application Data
(60) Provisional application No. 62/722,154, filed on Aug. 23, 2018.

(51) Int. Cl. A61H 1/00; A61H 23/00

(52) U.S. Cl. CPC A61H 1/008; A61H 2201/1695; A61H 2201/1664; A61H 23/00

(57) ABSTRACT

A multi-surface instrument for soft tissue mobilization is disclosed, the instrument includes a planar body having a periphery. In a first embodiment, the instrument further includes a hook element, a first round point having a first radius associated therewith, a second round point having a second radius associated therewith, wherein the second radius is larger than the first radius, and a rectangular surface. In a second embodiment, the instrument further includes a plurality of features, each of the plurality of features extends along the periphery of the planar body, wherein each of the features is independently one from the group consisting of: a convex surface, a concave surface, and a linear surface. Methods for using the instrument are also described.

### CROSS-REFERENCE TO RELATED APPLICATIONS

This application claims benefit of priority with commonly owned U.S. 62/722,154, filed Aug. 23, 2018; the entire contents of which are hereby incorporated by reference.

### BACKGROUND

### Field of the Invention

The invention relates to instruments for physical therapy; and more particularly, to a multi-surface instrument for performing one of a plurality of possible therapeutic treatments related to physical therapy, such as, for example, myofascial release, neural mobility, lymphatic mobility, vascular mobility, and nervous system stimulation.

### Description of the Related Art

Myofascial release is a type of physical therapy often used to treat myofascial pain syndrome. Myofascial pain syndrome is a chronic pain disorder caused by sensitivity and tightness in your myofascial tissues. These tissues surround and support the muscles throughout your body. The pain usually originates from specific points within your myofascial tissues called “trigger points.”

Myofascial release focuses on reducing pain by easing the tension and tightness in the trigger points. It's not always easy to understand what trigger point is responsible for the pain. Localizing pain to a specific trigger point is very difficult. For that reason, myofascial release is often used over a broad area of muscle and tissue rather than at single points.

Various instruments are available for executing myofascial release; however, there remains a need for improved instruments and overcoming various problems in the art.

### SUMMARY

A multi-surface instrument for soft tissue mobilization is described.

The instrument comprises a unique peripheral shape having a plurality of convex and concave surfaces, and corresponding indicia labeling each of the convex and concave surfaces for indicating a relation of each surface to an instructional protocol. The protocol may be provided in a publication, either electronically of via print media, or otherwise as may be communicated through any means, audio or visual. Certain example protocols are disclosed herein, including protocols for using the instrument to treat bicipital tendinopathy, and hamstring strain. Other protocols may be ascertained by one having skill in the art of physical therapy.

The instrument comprises a convex edge, or alternatively a beveled edge, for optimizing pressure with the instrument applied to the body of a patient in a direction parallel with the instrument edge (“splaying”), and for maximizing resistance when the instrument is applied to the body of the patient in a direction perpendicular to the instrument edge (“longitudinal”). Different protocols may require pressure or resistance, and thus various holding and translational techniques are required depending on the specific protocol.

The instrument further comprises a plurality of finger-apertures configured to provide a physical therapist or other user the option to hold the instrument in one of a plurality of possible ergonomic holding patterns or holding techniques. Depending on the treatment deployed, one or more of the convex and concave edges may be required, and one or more holding techniques may be of interest. The plurality of finger holes disposed on the instrument body provide a variety of options for holding the instrument in an ergonomic fashion according to the selected protocol being deployed.

Other features and advantageous effects will be understood by one with skill in the art upon a thorough review of the following detailed description.

### BRIEF DESCRIPTION OF THE DRAWINGS

These and other features of the invention will become apparent to one having the ordinary level of skill in the art upon a thorough review of the following details and descriptions, particularly when reviewed in conjunction with the drawings, wherein:

FIG. 1 shows a front view of a multi-surface instrument for soft tissue mobilization in accordance with an illustrated embodiment;

FIG. 2 shows a top view of the multi-surface instrument for soft tissue mobilization in accordance with the illustrated embodiment; and

FIG. 3 shows a rear view of the multi-surface instrument for soft tissue mobilization in accordance with the illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, and a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

### General Embodiments

In a general embodiment, a multi-surface instrument for soft tissue mobilization comprises: a planar body having a periphery associated therewith, wherein along the periphery is disposed at least: a hook element, a first round point having a first radius associated therewith, a second round point having a second radius associated therewith, wherein the second radius is larger than the first radius, and a rectangular surface.

The instrument may further comprise a plurality of apertures each extending through the planar body. The plurality of apertures may comprise five apertures, although any number of apertures may be similarly implemented and provide utility for holding the instrument. Each of the plurality of apertures may comprise a tapered edge for ergonomics and other benefits.

The planar body may form an edge extending along the periphery thereof. The edge may comprise an apex and a lancet arch incorporating the apex. The edge may be tapered.

The instrument may further comprise a plurality of indicium disposed on at least a first surface of the planar body and adjacent to the periphery. The plurality of indicium may comprise a series of integers, wherein each of said integers is positioned adjacent to one of a plurality of features of the instrument. Alternatively, the series of indicium may comprise letters or symbols.

The instrument may comprise a plurality of features extending along the periphery of the planar body, wherein each of the features can be independently selected to be one from the group consisting of: a convex surface, a concave surface, and a linear surface.

In another general embodiment, a multi-surface instrument for soft tissue mobilization comprises: a planar body having a periphery associated therewith, wherein along the periphery is disposed: a plurality of features, each of the plurality of features extending along the periphery of the planar body is independently one from the group consisting of: a convex surface, a concave surface, and a linear surface.

### Illustrated Embodiments

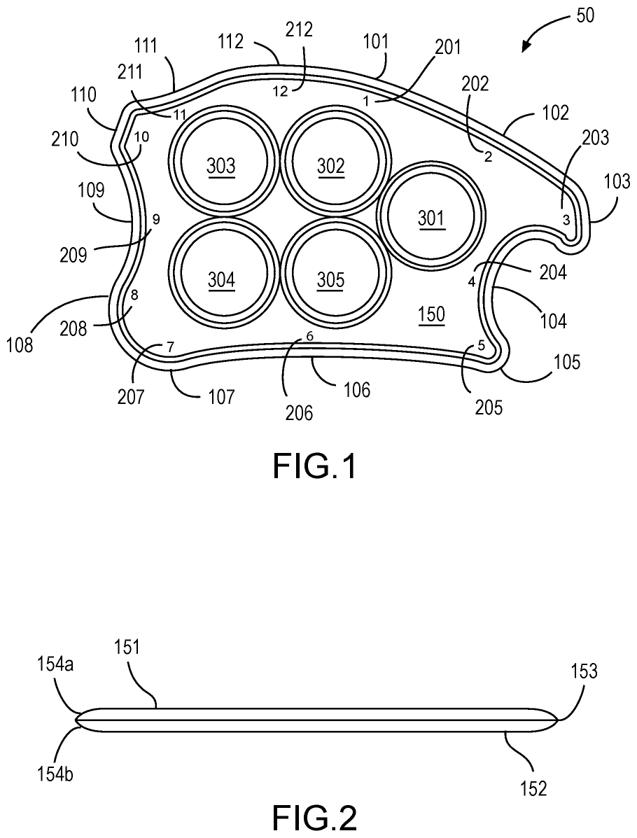

Now, with reference to the drawings, FIG. 1 shows a front view of a multi-surface instrument 50 for soft tissue mobilization in accordance with an illustrated embodiment. As shown in FIG. 1, the multi-surface instrument comprises, in order about a periphery of the instrument: a first surface 101 which is convex; a second surface 102 which is convex; a third surface 103 which is convex; a fourth surface 104 which is concave; a fifth surface 105 which is convex; a sixth surface 106 which is concave; a seventh surface 107 which is convex; an eight surface 108 which is convex; a ninth surface 109 which is concave; a tenth surface 110 which is linear; an eleventh surface 111 which is concave; and a twelfth surface 112 which is convex.

A hook element is formed about the periphery of the instrument extending from the second surface 102, through the third surface 103 and up to or adjacent to fourth surface 104.

A small round point is formed along the periphery extending between the fourth surface 104, fifth surface 105 and up to or adjacent to sixth surface 106.

A large round point is formed along the periphery of the instrument extending from the seventh surface 107 and through the eighth surface 108.

Moreover, a rectangular surface is formed along the periphery extending from the ninth surface 109 through the tenth surface 110 and up to the eleventh surface 111.

Adjacent to each of the twelve convex and concave surfaces (101 thru 112, respectively) are corresponding indicium (201 thru 212, respectively), wherein first indicia 201 corresponds to first surface 101; second indicia 202 corresponds to second surface 102; third indicia 203 corresponds to third surface 103; fourth indicia 204 corresponds to fourth surface 104; fifth indicia 205 corresponds to fifth surface 105; sixth indicia 206 corresponds to sixth surface 106; seventh indicia 207 corresponds to seventh surface 107; eighth indicia 208 corresponds to eighth surface 108; ninth indicia 209 corresponds to ninth surface 109; tenth indicia 210 corresponds to tenth surface 110; eleventh indicia 211 corresponds to eleventh surface 111; and twelfth indicia 212 corresponds to twelfth surface 112. The indicium may comprise numbers, letters, symbols, characters, or any indicia that may be used to communicate a corresponding surface of the instrument to a user.

Disposed through a planar body 150 of the instrument are a plurality of finger-receiving apertures (301 thru 305, respectively). First aperture 301 is disposed adjacent to second surface 102. Second aperture 302 is disposed adjacent to first surface 101. Third aperture is disposed adjacent to eleventh surface 111. Fourth aperture is disposed adjacent to seventh surface 107. Fifth aperture is disposed adjacent to sixth surface 106. While five finger-receiving apertures are illustrated, it should be understood that the instrument may comprise at least three and up to ten finger-receiving apertures for providing sufficient holding patterns for the various convex and concave surfaces of the instrument. Each of the finger-receiving apertures can be disposed one adjacent to another and/or about the periphery of the instrument.

FIG. 2 shows a top view of the multi-surface instrument for soft tissue mobilization in accordance with the illustrated embodiment. From this orientation, a front surface 151 and rear surface 152 of the instrument are labeled. The instrument is generally flat or planar, as shown. The instrument comprises a convex edge, that is, the edge comprises an apex 153 and the sides of the edge 154a; 154b collectively form a lancet arch with the apex as shown.

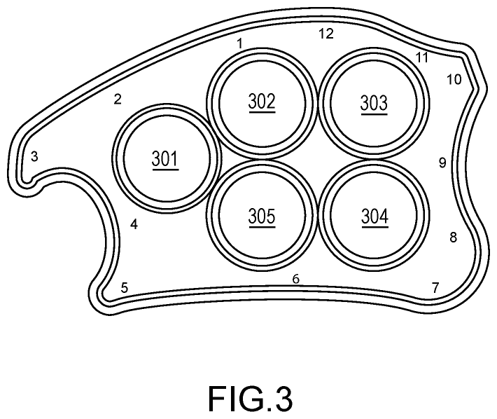

FIG. 3 shows a rear view of the multi-surface instrument for soft tissue mobilization in accordance with the illustrated embodiment. The rear surface is a mirror opposite of the front surface described above.

The instrument is preferably manufactured from stainless steel, and is autoclavable. However, the instrument may be fabricated from any metal, plastic, wood, glass, or other material as would be recognized by one having skill in the art to function according to the intended purpose of the instrument.

Where the instrument is manufactured from a metal, such as stainless steel, an automated computer numerical control (CNC) machine may be used to cut the periphery and apertures of the device, followed by a beveling machine or similar equipment to contour and deburr the edge of the instrument, further following by a polishing method using conventional polishing equipment.

Alternatively, a plastic instrument may be fabricated using conventional tooling and injection molding techniques. Moreover, three-dimensional printing (3D printing) can be similarly used to manufacture the instrument.

Other conventional manufacturing methods will be appreciated by one having skill in the art.

### Example 1: Protocol for Treating Bicipital Tendinopathy

In one embodiment, a protocol is described for treating bicipital tendinopathy.

Here, the patient is placed in the supine position, arm supported, and biceps brachii on slack. The clinician is standing.

The clinician uses the concave sixth edge 106, or ninth edge 109, to scan biceps brachii for fibrotic tissue. Next, the clinician uses convex twelfth edge 112 to treat muscle belly fibrotic tissue with longitudinal strokes. Next, the clinician uses hook edge 103 to decompress the biceps tendon. Finally, the clinician uses convex seventh edge 107, or tenth edge 110, to cross friction massage over the biceps tendon.

This protocol is particularly useful to treat bicipital tendinosis in late subacute or chronic stages. Experimental data shows moderate to low tissue reactivity.

### Example 2: Protocol for Treating Hamstring Strain

In another embodiment, a protocol is described for treating hamstring strain.

Here, the patient is placed in the prone position, pillows supporting tibiofemoral joint in 20° of flexion. The clinician is standing.

The clinician uses concave sixth edge 106 to scan semimembranosus and biceps femoris for fibrotic tissue. Next, the clinician uses convex twelfth edge 112, or seventh edge 107, to treat muscle belly fibrotic tissue with longitudinal strokes. Next, the clinician uses convex fifth edge 105, seventh edge 107, or tenth edge 110 to treat hamstring intermuscular septum with longitudinal and splaying strokes. Finally, the clinician uses hook edge 103 to decompress distal hamstring tendons.

This protocol is particularly useful to treat hamstring strain in late subacute or chronic stages. Experimental data shows moderate to low tissue reactivity.

1. A multi-surface instrument for soft tissue mobilization, comprising:
a planar body having a periphery associated therewith, wherein along the periphery is disposed at least:
a hook element,
a first round point having a first radius associated therewith,
a second round point having a second radius associated therewith, wherein the second radius is larger than the first radius, and
a rectangular surface.

2. The instrument of claim 1, further comprising: a plurality of apertures each extending through the planar body.

3. The instrument of claim 2, comprising five apertures.

4. The instrument of claim 2, wherein each of the plurality of apertures comprises a tapered edge.

5. The instrument of claim 1, wherein the planar body forms an edge extending along the periphery thereof.

6. The instrument of claim 5, wherein the edge comprises an apex and a lancet arch incorporating the apex.

7. The instrument of claim 5, wherein the edge is tapered.

8. The instrument of claim 1, further comprising: a plurality of indicium disposed on at least a first surface of the planar body and adjacent to the periphery.

9. The instrument of claim 8, wherein the plurality of indicium comprises a series of integers, wherein each of said integers is positioned adjacent to one of a plurality of features of the instrument.

10. The instrument of claim 9, wherein each of said features is independently one from the group consisting of: a convex surface, a concave surface, and a linear surface.

11. The instrument of claim 1, further comprising: a plurality of features extending along the periphery of the planar body, wherein each of said features is independently one from the group consisting of: a convex surface, a concave surface, and a linear surface.

12. A multi-surface instrument for soft tissue mobilization, comprising:
a planar body having a periphery associated therewith, wherein along the periphery is disposed:
a plurality of features,
wherein each of said features is independently one from the group consisting of: a convex surface, a concave surface, and a linear surface.

13. The instrument of claim 12, further comprising: a plurality of apertures each extending through the planar body.

14. The instrument of claim 13, comprising five apertures.

15. The instrument of claim 13, wherein each of the plurality of apertures comprises a tapered edge.

16. The instrument of claim 12, wherein the planar body forms an edge extending along the periphery thereof.

17. The instrument of claim 16, wherein the edge comprises an apex and a lancet arch incorporating the apex.

18.

19. The instrument of claim 12, further comprising: a plurality of indicium disposed on at least a first surface of the planar body and adjacent to the periphery.

20. The instrument of claim 19, wherein the plurality of indicium comprises a series of integers, wherein each of said integers is positioned adjacent to one of the plurality of features of the instrument.
